(19) United States
(12) Patent Application Publication
(10) Pub. No.: US 2008/0139055 A1
(43) Pub. Date: Jun. 12, 2008

(54) Electric Plug Contact

(75) Inventors: Jens Thorsten Gronau, Hameln (DE); Bernd Pohl, Garbsen (DE); Andreas Sievers, Sehnde (DE); Tino Wiggers, Seelze (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: WABCO GMBH & CO. OHG, Hannover (DE)

(21) Appl. No.: 11/662,681

(22) PCT Filed: Jul. 5, 2005
(86) PCT No.: PCT/EP05/07203

§ 371 Date: Mar. 12, 2007

(30) Foreign Application Priority Data
Oct. 7, 2004 (DE) 10 2004 048 975.0

(51) Int. Cl. H01R 4/50

(52) U.S. Cl. 439/863

(57) ABSTRACT

An electric plug contact for setting a contact between a component, in the form of an electrovalve or a sensor, and a base plate is provided. The plug contact includes fork-shaped contact elements which are fittable with each other by a 90° rotation and form an at least four-point electroconductive connection in plugged-in position.

### BACKGROUND OF THE INVENTION

The present invention relates to a new electric plug contact for establishing a secure electrical connection between a component and a base plate.

Electric plug contacts of the type in which a blade-shaped first contact part can be inserted into a fork-shaped second contact part are common for detachably connecting two electrical lines and are well known (see, for example, DE 32 42 635 C2 and DE 100 27 125 A1). In applications in which vibrations may occur between the two conductor parts to be connected, however, such conventional plug connections have the disadvantage that contact abrasion can be caused by mechanical rubbing action. Thus, the quality of the electrical connection may deteriorate over time.

DE 100 27 125 A1 describes an electric plug contact in which the fork-shaped contact part is designed to be flexible. Vibration-induced contact abrasion that may take place between the two lines to be connected is ostensibly precluded by the fact that the vibrations are absorbed by the flexible mounting of the fork-shaped contact part. However, with this known design, it is still possible for contact abrasion to occur due to turning movements between the two contacts. These turning movements are not absorbed by the flexible mounting of the fork-shaped part, and, in some cases, are even caused by it.

### SUMMARY OF THE INVENTION

Generally speaking, in accordance with the present invention, a new electric plug contact for effecting contact between a component (e.g., in the form of an electrovalve or a sensor) and a base plate is provided which overcomes disadvantages associated with conventional electric plug contacts.

It is an object of the present invention to provide a plug electrical contact connection which avoids contact abrasion due to turning movements between the parts to be contacted.

The electric plug contact according to the present invention includes forked contact elements which are fittable with each other by a 90° rotation and form an at least four-point electroconductive connection in plugged-in position.

Still other objects and advantages of the present invention will in part be obvious and will in part be apparent from the specification.

The present invention accordingly comprises the features of construction, combination of elements, and arrangements of parts which will be exemplified in the constructions hereinafter set forth, and the scope of the invention will be indicated in the claims.

### BRIEF DESCRIPTION OF THE DRAWINGS

The present invention will be described in greater detail hereinafter on the basis of the accompanying drawings, wherein:

FIG. 1 is a perspective view of two fork-shaped contact elements inserted into one another in accordance with an embodiment of the present invention;

FIG. 2 is a perspective view of a base plate equipped with contact elements, together with a component in separated condition but ready to be mounted, in accordance with an embodiment of the present invention; and

FIG. 3 is a perspective view of the base plate depicted in FIG. 2 with contact elements as well as the mountable component in connected condition in accordance with an embodiment of the present invention.

### DETAILED DESCRIPTION OF THE PREFERRED EMBODIMENTS

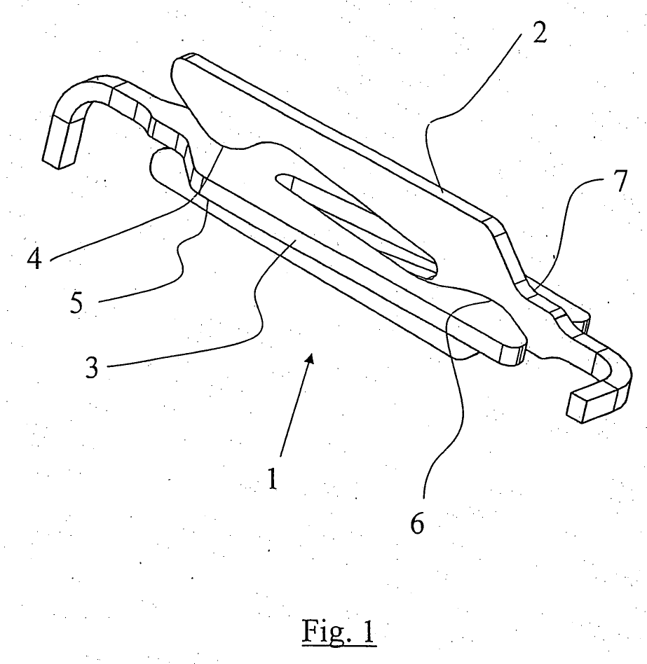

Referring now to the drawing figures, FIG. 1 shows, in a perspective schematic diagram, an electric plug contact (1) in accordance with a preferred embodiment of the present invention in interlocked condition. Plug contact (1) includes a first fork-shaped contact element (2) and a second contact element (3) of the same design. In the illustrated condition, the two contact elements (2, 3) form an electrically conductive connection at four points (4, 5, 6, 7).

The number of contact points can be increased (e.g., doubled) by notching the contact tabs (not illustrated) in the bearing face.

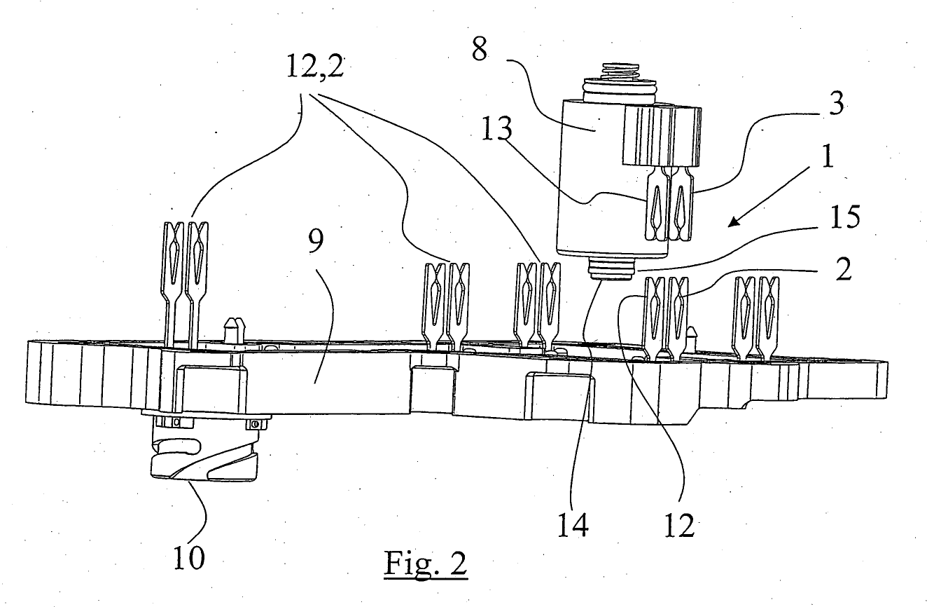

FIG. 2 shows a base plate (9) made from insulating material, on which there are mounted a plurality of pairs of vertically upright fork-shaped contact elements (2, 12). These are conductively connected to a stamped grid embedded in base plate (9). The corresponding conductor tracks of the stamped grid are led out internally to an electrical terminal contact (10).

FIG. 2 further shows a component (8), in the form of a solenoid valve or sensor, which component is not yet in connected condition. For electrical connection, component (8) is provided with two fork-shaped contact elements (3, 13) which are turned 90° relative to the corresponding contact elements (2, 12) disposed on base plate (9). Component (8) is further provided with a connecting port (14) of circular cross section by means of which component (8) can be inserted into a corresponding opening in base plate (9). In the inserted condition, sealing against gaseous or liquid media is achieved by a seal ring (15).

It should be appreciated that still further components, not illustrated, can be mounted on base plate (9) and connected electrically to further contact elements (2, 12).

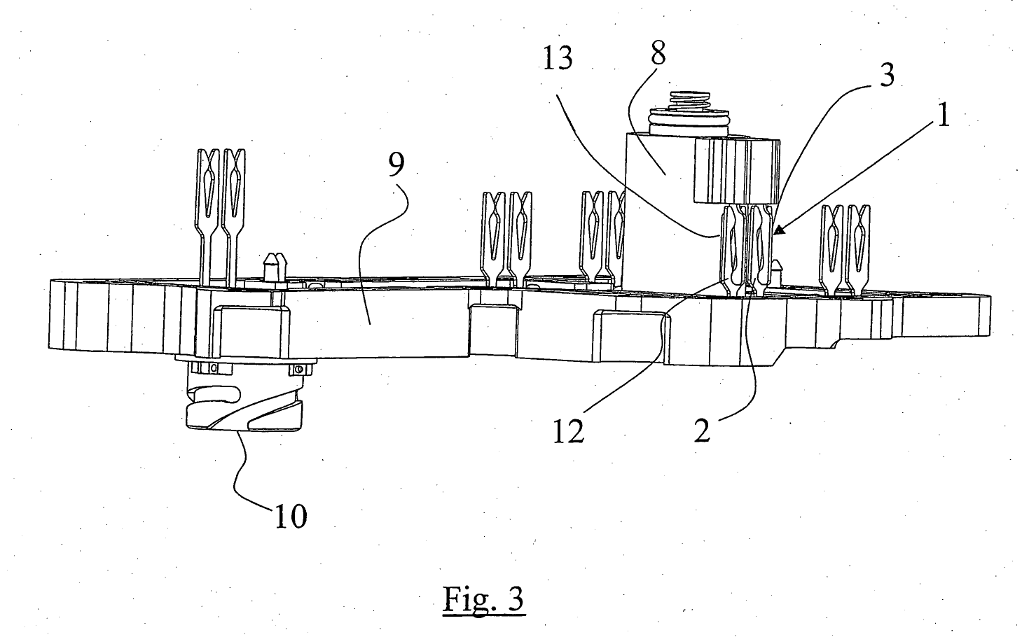

FIG. 3 shows base plate (9) with component (8) in inserted condition. As is evident, a secure electrical connection is provided by the fork-shaped contact elements (2, 3) and (12, 13) inserted into one another. This is maintained even if shaking of base plate (9) occurs or if vibrations exist between base plate (9) and component (8). Preferably, lower contact elements (2, 12) are mounted flexibly.

In the inserted condition of component (8), a pressure-tight connection with a connecting duct contained in base plate (9) is established by connecting port (14) as well as seal ring (15). Component (8) is capable of performing its function as a solenoid valve or as a sensor (e.g., pressure sensor), for example.

It should be appreciated that, by virtue of the present invention, no relative motion in longitudinal direction occurs between the contacts. Furthermore, rotational movement also does not occur by virtue of the inventive construction of the contacts as fork-shaped elements insertable one into the other. Thus, contact abrasion is avoided. Indeed, testing has demonstrated that contact wear due to contact friction is prevented by the present invention, even in the presence of intense vibrations and shaking. Also, the quality of the electrical contact can be maintained over a long time period.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. An electric plug contact for electrically connecting at least one component, consisting of at least one of a solenoid valve and a sensor, with a base plate, said at least one component being mountable on said base plate and including a connecting port for engaging said base plate to form a substantially pressure-tight connection, said electric plug contact comprising first and second contact elements, said first and second contact element each having extending forked prongs, said first contact element being constructed and arranged to be placed in electrical communication with an electrical terminal contact, and said second contact element being matable with said first contact element when turned 90° relative to said first contact element, whereby said first contact element, when mated with said second contact element, contacts said second contact element 3 at at least four points of contact, and whereby an electrical connection is effected between said at least one component and said base plate when said at least one component is mounted on said base plate and said first and second contact elements are mated with one another.

2. (canceled)

3. (canceled)

4. (canceled)

5. (canceled)

6. (canceled)
